(19) United States
(12) Patent Application Publication
(10) Pub. No.: US 2005/0102248 A1
(43) Pub. Date: May 12, 2005

(54) A METHOD AND SYSTEM FOR DESIGN, MANAGEMENT AND EVALUATION OF COMPLEX INITIATIVES

(76) Inventors: Gunnar Backman, 740 82 Orsundsbro (SE); Tomas Erlandsson, 117 61 Stockholm (SE); John Nash, Menlo Park, CA (US)

Correspondence Address: FASTH LAW OFFICES, 629 E. BOCA RATON ROAD, PHOENIX, AZ, 85022, US

(21) Appl. No.: 10/605,477

(22) Filed: Oct. 1, 2003

Related U.S. Application Data
(60) Provisional application No. 60/319,589, filed on Oct. 2, 2002.

(51) Int. Cl. G06N 5/02; G06F 17/00

(52) U.S. Cl. 706/47

(57) ABSTRACT

A proposition (100) is obtained from a source (102). The process steps (104, 106, 108, 110) are then conducted and the results therefrom are stored in a storage unit (112). Information about a proposition is retrieved from the source in order to specify the proposition into non-ambiguous causal statements that are easy to agree on. Ultimately, this information is transferred into a logic map that graphically represents the initiative and serves as a guide to the management and evaluation of the project. Particularly, the logic map (12) has a context (14). An input (16) is linked to an effect (20) and a goal or goals (24, 25).

### BACKGROUND OF INVENTION

Many projects fail because they are built on implicit assumptions, the project goals are inadequately defined, or significant elements, which ultimately determine the level of success, are not properly negotiated between the persons involved. One reason why certain initiatives do not succeed is that certain information is not properly communicated that, in turn, often leads to misunderstanding and unreasonable expectations.

Effective management of a new initiative, before it becomes a project, often leads to significant improvements regarding goal fulfillment, project outcomes and profit.

The realization of an idea or a new initiative involves efforts to establish a change from one state or condition to another. There is a need for a system that provides a method to explore how change can manifest and lead to success in an envisioned project. There is also a need for a system that helps users explore how a new initiative can be feasible. It is also desirable to develop a method to determine if an envisioned project is important and desirable before the project is started.

### SUMMARY OF INVENTION

The present method and system provide a solution to the above-outlined problems. The disadvantages and problems associated with conventional systems and methods for designing, managing and evaluating projects have been substantially reduced or eliminated. More particularly, the method of the present invention is for design, management and evaluation of complex initiatives. A person using the system may answer questions from a human facilitator who is skilled and versed in the method. The system could also be fully automated and computerized.

One purpose of the method of the present innovation is to retrieve all information about a proposition from a person or a group of stakeholders (the source) in order to specify the proposition into non-ambiguous causal statements that are easy to agree on. Ultimately, this information is transferred into a special diagram, called a logic map that graphically represents the initiative and serves as a guide to the management and evaluation of the project. Particularly, the system of the present invention has a logic map that includes a context unit and an initiative segment.

A proposition may consist of all reasoning made by a source on an assumption, statement or fact about how a change of state, condition or status can be accomplished within the framework of an initiative. The source may include individuals such as sole individuals, teams, organizational units, companies etc., and documents such as project proposals, project descriptions, evaluation reports, digital media etc.

The method of the present invention provides stakeholders with a specific understanding of how likely it is that the stakeholders' plan for the initiative will lead to goal attainment. By doing this, the stakeholders gain insight and a higher level of understanding of the initiative and may act to reduce obstacles for becoming productive, such as vagueness and multiple meanings, and enhance chances of becoming more effective by building the initiative on non-ambiguous activities and resources directly and logically linked to the intended goals.

With this in place, a complete and coherent logical description of the initiative can be presented to all stakeholders who can then arrive at a shared understanding about how the initiative should work. Continued updates during the implementation phase serves as a tool for the stakeholders to manage and maintain the initiative relative to external and internal factors of change.

Preferably, the logic model is not syntax dependent, but instead relies on semantic evidence (mode of expression or rhetoric) presented by the stakeholders. Example application areas include innovation management, management of new initiatives, initiatives of a certain complexity, multiple-stakeholder initiatives and initiatives that aim at co-dependently developing and implementing new knowledge.

### BRIEF DESCRIPTION OF DRAWINGS

FIG. 1 is a schematic description of solicitation of the proposition, process steps, knowledge storage and logic mapping; and

FIG. 2 is a schematic diagram of an illustrative example of an information flow of a portion of the method of the present invention.

### DETAILED DESCRIPTION

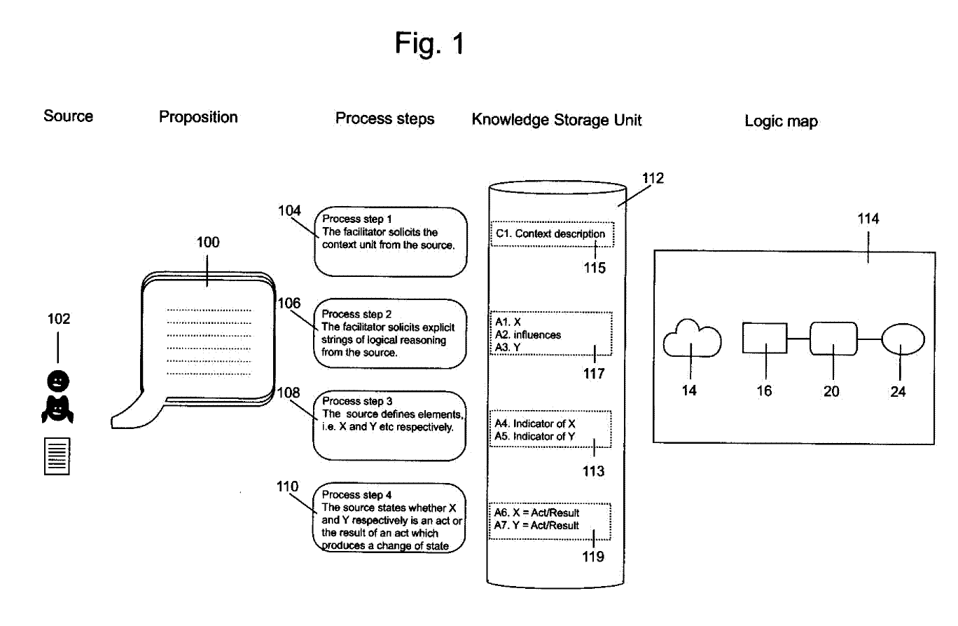

With reference to FIG. 1, the process steps of the present invention aim at examining a proposition 100 from a source 102 through interviews and/or document reviews in order to find and make explicit strings of logical reasoning which compose the proposition 100 and to develop these strings into non-ambiguous elements expressing causal statements. The process steps 104, 106, 108, 110 are continued until the strings of logical reasoning are exhausted.

The result of the process steps may be stored in a knowledge storage unit (KSU) 112, as described below. The process steps can be facilitated by an external facilitator or pursued independently by source individuals or groups. The envisioned audience for the outcome of the process steps may be called a target group. The source, the facilitator and the target group could, theoretically, be the same. The facilitation can be provided by one or several individuals or be performed by a computer-assisted facilitation (CAF) unit.

In the first process step 104, the facilitator solicits the context unit from the source 102. The source is asked to specify what motivates the initiative. In the second process step 106, the facilitator solicits explicit strings of logical reasoning from the source. The source may be asked to formulate what the initiative seeks to attain. Each item of information, referred to as an element, must be expressed non-ambiguously.

In the third process step 108, the source defines elements such as X and Y elements etc., respectively, by stating their method of measurement and at what level the element measure is fulfilled, which is called an indicator. In the fourth process step 110, the source states whether the X and Y elements, respectively, are an act or the result of an act, which produces a change of state. A result produced within the initiative may be referred to as an effect. A core effort and important feature of the present innovation is to make explicit the source's assumptions on how an effect is expected to appear.

All elements stored compose the storage unit 112 or KSU of the context unit and the non-ambiguous causal units such as an X→Y unit. The storage space can be a database, documents or human memory. When an indicator or indicators 113, such as indicators of the X and Y elements, are established it may be concluded that a set of goals 25 is measurable. The X or Y elements 113 may be stated as an act or result 119 and become an input 16 in the logic map 114. The X or Y element 113 that is stated as a result of an act that produces a change of a state 119 may become an effect 20 or goal 24 in the logic map 114. The context description 115 may become a context 14 in the logic map 114.

Simultaneously with process steps 104-110 or, after the process steps are completed, the elements in the KSU can be transformed into a logic map 114. The logic map visualizes the context and the relationship between all X elements and all Y elements and describes the structure of logic reasoning of the proposition. Each element in the logic map may have a graphic representation and are connected into a web of causal influences according to the principles described below.

The map's context unit may be created from the retrieved information and may be represented by a cloud sign. The map's initiative segment may be created from the non-ambiguous “X influences Y” -units in the following way:
1. Identify all identical Xs and Ys elements, i.e. X and Y elements defined by the same indicator, and bundle these according to the principle:
2. Place or draw all X and Y elements on a surface including influence arrows in accordance with the process results
X₁→Y₁, X₂→Y₂, where X₁ and X₂ correspond gives X₁→Y₁ and Y₂
X₁→Y₁, X₂→Y₂, where X₁ and Y₂ correspond gives X₂→X₁→Y₁
X₁→Y₁, X₂→Y₂, where Y₁ and X₂ correspond gives X₁→Y₁→Y₂
X₁→Y₁, X₂→Y₂, where Y₁ and Y₂ correspond gives X₁→Y₁ and X₂→Y₁
3. The source or the target group identifies X and Y elements as input (activity or resource), effect (change of state resulting from an input or other effect) or goal (ultimate change or changes of state of the initiative).

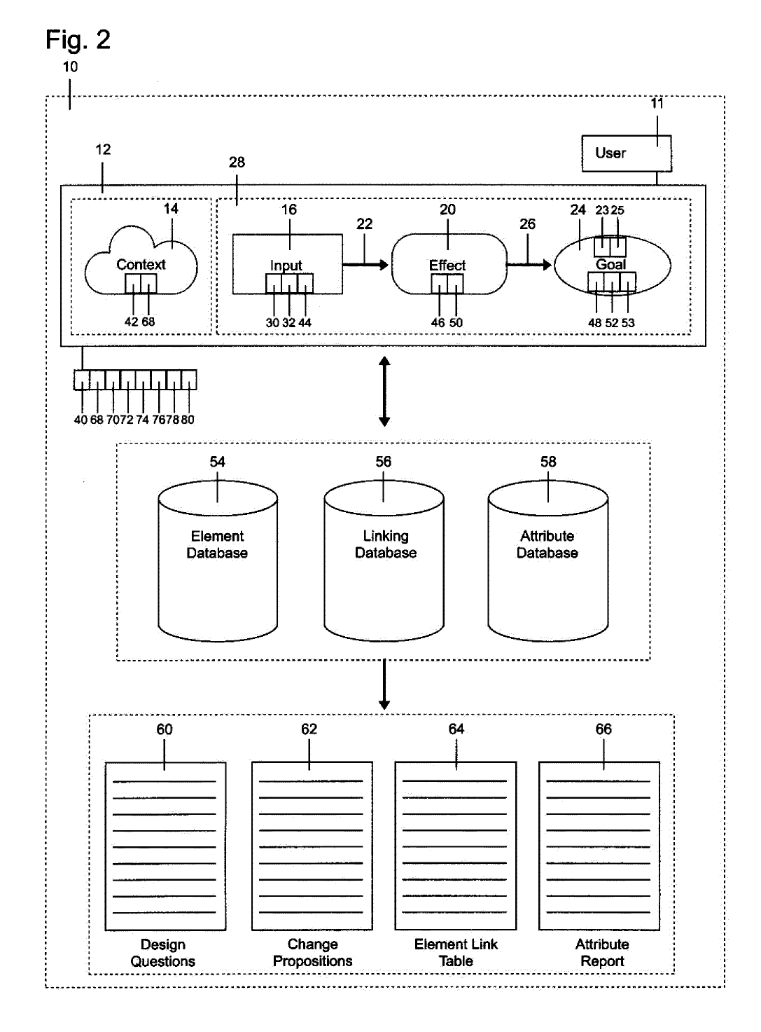

With reference to FIG. 2, the method and system 10 of the present invention has, as indicated above, a logic map 12 that includes a context unit 14 and an initiative segment 28. The map 12 may be used for one or many initiatives and for one or many users 11.

The system 10 may be in face-to-face communication and be supported by suitable software. In general, the method has both graphically-visualized and text-based components that describe what stakeholders believe must be achieved, and how, in order to reach the goal. The method relates, in logical fashion, components of the initiative to its stakeholder interests, needs and requirements. The method describes how likely an innovation will lead to its intended results. It helps all stakeholders to arrive at a shared view and to determine if and why the initiative is important.

The initiative 28 may include an input unit 16, an effect unit 20 and a goal unit 24. As described below, the unit 16 is associated with the effect unit 20, via a link or influence arrow 22 that in turn is associated with a goal unit 24, via a link or influence arrow 26. The system 10 of the present invention is particularly useful for establishing what it is the user would like to accomplish and how the user can achieve the goals set out for complex initiatives.

As indicated above, the system 10 may be used to decode or clarify the complexity of tasks. In the logic map 12, the context 14 may be illustrated as a cloud, the input unit 16 as a rectangle, the effect unit 20 as a rectangle with rounded corners and the goal unit 24 may be illustrated as an oval. Of course, other symbols may be used, as desired. Also, the elements 14-24 could be performed in any suitable order and the order described herein is only an illustrative example.

A user 11 of the system 10 may set out a perceived goal 23 that may be a goal that the user believes is the correct goal for the initiative 28. At this point, any goal 23 is acceptable even if the goal is not reachable or measurable. The system 10 may then ask the user 11 to specify the problems or needs 68 that are satisfied or motivated by the goal 23. The problems that require a solution or the needs 68 may be included in the context unit 14 and could be any suitable needs such as perceived and assumed needs, political or ideological assertions and/or proven problems, opportunities, requirements or desired changes of existing conditions. For example, the needs could be higher economic growth, better teaching of the children or cleaner air.

The initiative 28 may be the name of a project or a program that includes a description of how a number of stakeholders may accomplish certain effects and goals. When the issues are complex and there are many stakeholders or interested parties, the system 10 may be a useful tool to organize the issues and to simplify the negotiations between the stakeholders.

When the needs and the goals have been outlined, the user 11 may then be asked to list or define the input 16 of the initiative 28. The input 16 could be activities 30 or resources 32 that are made available to the initiative 28 and are expected to contribute to the fulfillment of the goals.

An important aspect of the system 10 is to develop logical connections or links between the activities of input unit 16 and their effects that eventually lead to the perceived goals 23. Typically, in many initiatives that fail, there is often no direct logical connection between the needs of the context 14 and the elements of the initiative 28. For example, the context 14 is often merely the reason for the activities 30 of the input unit 16. The integration of the initiative 28 of the input unit 16, the effect unit 20, the goal unit 24 together with influence arrows 22, 26 should correspond to the needs of the context 14. As described in detail below, the activities 30 of the input unit 16 produce effects that are listed in the effect unit 20 and the resulting goals listed in the goal unit 24. The needs or the problems of the context 14 themselves usually do not directly influence the linking of the elements of the initiative 28. However, the context 14 may be seen to govern or justify the entire initiative 28.

Once the goals 23 and the context 14 have been established by the user 11, it may be necessary to break down the goal 23 into components to determine what is required to accomplish the goals 23. For example, the goals 23 may be used to govern the type of activities 30 and resources 32 that should be listed in the input unit 16.

Once the activities 30 and the resources 32 have been identified, the user may establish the expected effect or effects 20 that may occur as a result of influences from the activities and resources of the input unit 16. The influences or connections between the activities of the input unit 16 and the effects of the effect unit 20 may be illustrated with the influence arrow or arrows 22. During the process of setting up the elements of the initiative 28, the user 11 often realizes that the perceived or preplanned activities that are necessary to reach the goals 23 actually do not lead to the perceived goals 23. Another problem is that the user may define something as a goal when it is really an activity or effect. The actual goals 25, as a result of the analysis of the items in the input unit 16 and the effect unit 20, may be different from the perceived goals 23.

One aspect of the system 10 is a computerized tool 40 that is set up to follow certain rules of the logic map 12. For example, the tool 40 may not permit the user 11 to draw influence arrows from the goal unit to the effect, in-put or context units. The tool 40 may initially only show the items of the context 14 and the list of goals 23 of the goal unit 24 so that the user 11 can see if there seems to be an apparent match between the context information and the goals. At this point, it is not necessary or desirable to involve the input and effect units including the influence arrows therebetween. Also, it is not necessary to match a certain item in the context unit with a certain goal of the perceived goals 23. The user may simply realize that many context items may correspond to one goal and vice versa without drawing lines therebetween.

When using the tool 40, the user 11 may click on the elements 14, 16, 20 and 24 to see attributes 42, 44, 46 and 48 of the elements 14, 16, 20, 24, respectively. Each element may have the same or different attributes. The attributes may be data with which the elements are specified. More particularly, each element 14, 16, 20, 24 of the system 10 has many standard attributes such as definition attributes 68, rationale attributes 70, external influencing factor attributes 72, measuring point attributes 74, reference attributes 76, introducing party attributes 78 and stakeholder attributes 80. In general, all elements of the initiative must meet the requirements of the definition attributes 68 before the elements are accepted in the logic map 12.

The definition attributes 68 of an element describe or define the element to clarify abstract and undefined statements so that the statements include quantitative indicators. Instead of using a vague statement such as “good service” the element may be made more specific such as “respond to customer requirements within five hours” so that all the stakeholders can understand what is meant and so that the element may be measured.

The rationale attributes 70 show how an element contributes to the fulfillment of the goal. It shows why the element is important to achieve the goal so that the parties can analyze, negotiate and prioritize the importance of the element.

The external factor attributes 72 are success and risk factors that affect the ability of the element to fulfill the goal. The external factor attributes 72 are often factors beyond the control of the initiative 28. For example, a stock exchange crash may be an uncontrollable factor that may significantly affect the success of the initiative. One purpose of the factor attributes 72 is to make the stakeholders aware of the external factors. The failure of the initiative may be due to the external factors and not due to faulty assumptions or poor implementation of the initiative.

The measuring point attributes 74 relate to the issue whether the input, effect or goal should be measured or not. It may not be necessary to measure all the elements due to limited resources. Certain elements may be critical and should therefore be measured while other elements seem particularly weak or strong for the initiative and should therefore be measured so that it is possible to mark the elements that seem more critical to the fulfillment of the goal or seem to be of a particular interest to one of the stakeholders.

The reference attributes 76 are used to describe the source references, such as documents, experts, web pages etc., to all the stakeholders so that a knowledge database may be built up.

The introducing party attributes 78 show that suggested the element so that proposed element can be properly analyized and prioritized during the negotiation between the stakeholders. Stakeholder attributes 80 may be the name of the parties who are interested in the element.

The actual goals 25 should have quantitative and qualitative characteristics. The goals 25 should correspond and satisfy one or many of the items in the context unit 14. The goals 25 should be measurable. The formulation of the goals 25 should indicate which indicators are used to determine if the goals are satisfied. If it is not possible to use measurable indicators, the goal should be reformulated. The goals 25 should be reachable and contribute something to the initiative 28 such as a change, a new condition or a new status. The goals 25 should be concrete and clear so that all the stakeholders can understand what is meant by the goal and what should be satisfied and how the fulfillment of the goals can be determined.

If the goal 25 does not satisfy or correspond to the needs of the context 14, then a new goal 52 must be established with the help of the input activities and how the activities influence the effects 50 of the effect unit 20. If the goal 25 is not measurable then a new measurable goal 53 must be established or reformulated. The user may be more suitable to determine whether the qualitative aspects of the goal 25 are satisfied. The user may determine if the goal is achievable and whether the goal contributes to a useful change according to the view of the user. The goals could later be used for meaningful discussions and negotiations between the stakeholders.

For example, each stakeholder is likely to identify different input activities that are required to achieve the goals. The more difficult step is to determine how the activities affect the effects that are linked by influence arrows. The arrows may be used to identify the effects 50 of the effect unit 20 that the input activities influence. Eventually the effects should lead to the goal 25 or to a different goal.

Once the initiative 28 has been completed, the initiative may be evaluated such as by analyzing whether the activities were carried out or not and whether the required resources were allocated or not. A common reason for not reaching the goal is that the initiative did not receive sufficient resources.

While the initiative is under way, or after the completion of the initiative, it may be possible to add an activity to strengthen the initiative so that the new activity and the old activities are used together to increase the chances of achieving the goal.

The effects are also evaluated to determine if the effect happened or not. If the effects were not accomplished, the input activities and resources may be investigated to determine why the particular effect did not occur.

When the tool 40 is used, the elements 14, 16, 20, 24 may be saved in an element database 54 and the links between the elements, as shown by the influence arrows 22, 26 may saved in a linking database 56. The attributes or metadata may be saved in an attribute database 58.

The databases 54, 56, 58 of the tool 40 may be used to produce a design question report 60, a change proposition report 62, an element link table 64 and an attribute report 66. The report 60 may show the questions that were used to develop the logic map 12 so that the user can both see and hear the questions to further reflect and think about the questions. The report 62 is a complete logic map that may be used to propose a change. Because the report 62 has all the logical reasoning behind the goal it may be a complete and fully developed and persuasive initiative. The table 64 presents all the linked elements in a table format. The attribute report 66 shows all the attributes for each element 14, 16, 20, 24.

By requiring all information in the input unit 16, the effect unit 20 and the goal unit 24 to be measurable, it is easier to evaluate later whether the activity elements were carried out or not, whether the effects occurred or not and whether the goals were fulfilled or not.

While the present invention has been described in accordance with preferred compositions and embodiments, it is to be understood that certain substitutions and alterations may be made thereto without departing from the spirit and scope of the following claims.

1. A method for articulating initiatives by using a logic map, comprising:
obtaining a proposition (100) from a source (102);
conducting process steps (104, 106, 108, 110);
storing results from the process steps in a storage unit (112);
transforming results stored in the storage unit (112) to a logic map (12) having a context (14) and an initiative (28), the initiative (28) comprising an input (16) linked to an effect (20)that is linked to a goal (24) identifying the context (14);
identifying a perceived goal (23) that corresponds to the context (14);
identifying the input (16) and the effect (20) that results in the perceived goal (23);
determining whether the effect (20) is measurable, as indicated by an indicator (113), and reformulating the effect (20) when the effect is not measurable;
linking the activities and resources (30) to the effect (20) with a linking segment (22); and
linking the effect (20) to at least one of the goals (25) with a linking segment (26).

2. The method according to claim 1 wherein the proposition from the source is specified into non-ambiguous causal statements consisting of elements described as X-elements that influences Y-elements;

3. The method according to claim 2 wherein the method further comprises creating non-ambiguous statements regardless of any semantics through definitions of X and Y-element indicators.

4. The method according to claim 3 wherein the method further comprises defining an indicator for X and Y elements by stating a method of measurement and at what level an element measure is fulfilled.

5. The method according to claim 2 wherein the method further comprises the source stating whether the X and Y elements are an act or a result of an act that produces a change of a state.

6. The method according to claim 1 wherein the method further comprises concluding that a set of goals (25) is measurable when an indicator (113) is established.

7. The method according to claim 1 wherein the method further comprises the logic map visualizing relationships between the X elements and Y elements.

8. The method according to claim 6 wherein the method further comprises the X or Y elements (113) that are stated as an act (119) becoming an input (16).

9. The method according to claim 6 wherein the method further comprises the X or Y (113) that are stated as a result of an act that produces a change of a state (119) becoming an effect (20) or goal (24).

10. The method according to claim 6 wherein the method further comprises a context description (115) becoming a context (14).
